(19) United States
(12) Patent Application Publication
(10) Pub. No.: US 2025/0354409 A1
(43) Pub. Date: Nov. 20, 2025

(54) SELF-PROTECTING DOOR HANDLE ASSEMBLY

(71) Applicant: Sargent Manufacturing Company, New Haven, CT (US)

(72) Inventors: David Diaz Martinez, Tlajomulco De Zuñiga (MX); Marisol Mael Lara Gomez, Guadalajara (MX); Efrain Alejandro Perez Morales, Tlaquepaque (MX)

(73) Assignee: Sargent Manufacturing Company, New Haven, CT (US)

(21) Appl. No.: 19/184,594

(22) Filed: Apr. 21, 2025

Related U.S. Application Data
(60) Provisional application No. 63/649,819, filed on May 20, 2024.

(51) Int. Cl. E05B 13/00; E05B 1/00

(52) U.S. Cl. CPC E05B 13/002; E05B 1/003

(57) ABSTRACT

Disclosed herein is a self-protecting door handle assembly. The door handle assembly may retract a lever which prevents an operator from actuating the door handle assembly. While in a retracted configuration the lever may be restricted by a restricting surface. Additionally, the lever may be substantially flush to the baseplate while in the retracted configuration. While in the extended configuration the lever may be sufficiently distanced from the baseplate to allow an operator to grab and actuate the lever. In this configuration the lever may no longer be restricted by the restricting surface.

### CROSS-REFERENCE TO RELATED APPLIATIONS

This application claims the benefit under 35 U.S.C. § 119(e) to U.S. Provisional Application Ser. No. 63/649,819, entitled “SELF-PROTECTING DOOR HANDLE ASSEMBLY,” filed May 20, 2024, which is incorporated herein by reference in its entirety.

### FIELD

Disclosed embodiments relate to self-protecting door handle assemblies, such as door handles assemblies that are capable of retracting a lever.

### BACKGROUND

Conventional door latches typically include a fixed but rotatable handle, such as a lever, for user actuation. Conventional door locks may include an actuation handle that is inoperative when the door lock is in a locked state. When the door lock is in a locked configuration, the lock may be tampered with, and the lever may be actuated in order to open the door. Accordingly, self-protected door handle assemblies have been employed in order to render the lock more secure. A self-protected door handle assembly is a type of lock that provides an additional layer of security to a container or building. It may comprise a locking mechanism that has a built-in system which resists forced entry attempts. The door handle assembly may be configured such that when the door is locked, the lever is hidden in order to make it difficult for someone to bypass the lock and open the door. In other embodiments a shield may be deployed in order to cover portions of the handle susceptible to forced entry attempts.

### SUMMARY

In some embodiments the device described herein relates to a self-protecting door handle assembly comprising a baseplate, an escutcheon fixedly attached to the baseplate, a lever base protruding from the escutcheon wherein the lever base is rotatable, and a lever disposed adjacently from the lever base wherein the lever may pitch and roll and wherein the lever is configured to roll into a protected configuration when the door handle assembly is in a locked configuration.

In some embodiments the device described herein relates to a method of operating a self-protecting door handle assembly comprising locking the door handle assembly, rolling a lever from an unprotected configuration to a protected configuration, wherein rolling the lever comprises rolling the lever on an axis parallel to the lever but offset from a center of the lever such that the positioning of the lever changes, and contacting the lever against a restricting surface such that the lever is now restricted from actuating.

In some embodiments the device described herein relates to a method of operating a self-protecting door handle assembly comprising unlocking the door handle assembly, rolling a lever from a protected configuration to an unprotected configuration, wherein rolling the lever consists of rolling the lever on an axis parallel to the lever but offset a distance greater than the distance between a lever base and an escutcheon such that the positioning of the lever changes, and removing the lever from contacting a restricting surface such that the lever is now unrestricted and able to actuate.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 depicts an embodiment of a door handle assembly;

FIG. 2 illustrates an exploded view of the door handle assembly of FIG.1;

FIGS. 3A-3C illustrate the lever transforming from the retracted state to the extended state;

FIG. 4A depicts a top perspective view of the door handle assembly;

FIG. 4B depicts a bottom perspective view of the door handle assembly;

FIG. 5 depicts a right-side perspective of the lever door handle assembly; and

FIGS. 6A-6B illustrate the process in which the lever may be retracted and extended.

### DETAILED DESCRIPTION

In some embodiments, door handle assemblies are designed with an escutcheon, a lever base, and a lever. A user can actuate the lever to operate the door handle assembly. The actuation may be in the form of applying a downward force such that the lever pivots and the door is now free to open.

The door handle may be associated with a door lock. When locked, the lever may be restrained by a locking feature, which is intended to prevent the lever from actuating. Many door handle door assemblies have internal components that when locked, prevent the lever from being actuated. However, if an operator attempts forced entry through picking the lock, brute force, or other methods, the locking mechanism which restricts the lever from being actuated may be overpowered.

Accordingly, an apparatus which retracts the lever may provide further safety when used alone or in combination with interior locking components. In this regard, it should be appreciated that the disclosed embodiments herein may be used with a door lock or an unlocking door latch assembly.

While a conventional retracting lever provides an additional level of security by preventing an operator from securely grasping the lever, the Inventors found that there is a need for additional security in door handle assemblies which are able to retract the lever.

In view of the above, the Inventors have recognized and appreciated that retracting the lever of the door handle assembly into a configuration such that it is both more difficult to grasp and is mechanically restricted from actuating improves the security of the overall system from the threat of forced entry. This device may be considered a self-protecting door handle assembly. Other benefits of this system may include but are not limited to the following.

With the lever being retracted when locked, the lever may function as a locking status indicator. An operator can identify the locking status of the door handle assembly by simply looking and identifying if the lever is in the retracted or extended configuration. In some embodiments this may assist in simplifying the system such that other physical or visual indicators are not present and thus do not complicate the user interface.

With the lever being retracted, the lever may provide anti-ligature properties to the device. This is true if the lever base and escutcheon are designed such that the geometry of the components cannot support a ligature. This complementary function may be particularly useful where people pose a threat to themselves or others and must be contained in a room where no one, including themselves, can get hurt.

With the lever being retracted, a person is no longer at risk of inadvertently making contact with the lever and injuring themselves. This may provide value in childcare facilities, or anywhere a protruding door lever may be dangerous.

A retracted lever may also assist in creating a sleek or modern appearance. This may provide value in rooms where a protruding lever would obstruct the design of the room.

As mentioned above, the advantages of this system are not limited to the examples described.

It should be noted that while exemplary embodiments describe a door handle assembly, it should be noted that the retracting lever and restricting surface features may be employed on any lock to allow for increased security and a simpler user interface. For example, any lock which utilizes lever actuation may employ the restricting surface and retracted configuration described below. The retracted configuration is generally a protected configuration which prevents an operator from actuating the lever. The extended configuration is generally an unprotected configuration which allows an operator to actuate the lever.

In some embodiments, the door handle assembly may comprise an electronic keypad, biometric scanner, physical keyhole, or any other lock interface or combination of interfaces suitable for retracting or extending the lever and/or unlocking and locking the door handle assembly. The user interface may be disposed on any surface that is reasonably accessible to the user. This includes but is not limited to on the base of the door handle assembly, on the wall next to the door where the door handle assembly is installed, or on the lever base. When the proper credentials or key are presented, the lever will move to the extended or retracted configuration and/or door handle assembly will lock or unlock. The lever may be moved between retracted and extended configurations electronically or manually depending on the needs of the system. This door handle assembly may be present on both sides of the door or on just one side.

According to some embodiments, a motor may rotate the lever along an axis parallel to said lever such that the lever is located directly adjacent to an escutcheon or base plate of the door handle assembly. The rotation of the lever along this axis may be considered rolling to one of ordinary skill in the art. This movement is in a different direction than the rotation of the lever when the door handle assembly is actuated by a user. In that case the rotation may be described as pitching by one of ordinary skill in the art. In some embodiments the lever may be rolled or pitched clockwise or counterclockwise.

In some embodiments, the lever may be able to rotate independently of the locking status of the door handle assembly. Accordingly, in some embodiments the motor may be able to operate independently of the door handle assembly's locking apparatus. This feature may provide value in cases where the door is intended to be operatable from one side but not from the other. For example, the door handle assembly may be in the unlocked configuration, but if one side of the door has the handle in the retracted configuration, an operator on that side of the door would not be able to actuate the lever and open the door. However, an operator on the other side of the door may use the extended lever and open the door.

In some embodiments, when installing the door handle assembly, the door may be retrofitted in a manner consistent with standard preparation. This process includes a face hole which is backset 2.375″-2.75″ and has approximately a 2.125″ diameter. A faceplate is present with a latch hole that has a diameter of approximately 1″. Any other door preparation technique may be used in order to prepare for installing the door handle assembly. Although not pictured in the figures described below, it should be understood that any door may integrate the door handle assembly disclosed herein.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

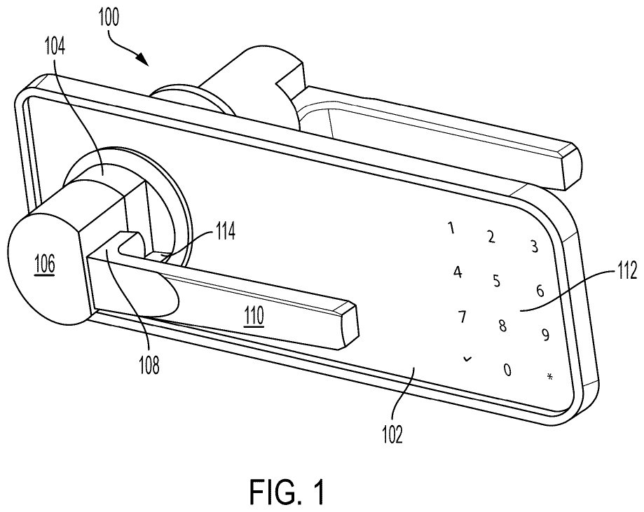

FIG. 1 depicts an embodiment of the door handle assembly 100. In this embodiment a baseplate 102 is present. The baseplate 102 houses a keypad 112 which may be operated by a user. The keypad 112 is used to enter credentials so that the lever 110 may be extended or retracted when a correct code is entered by an operator. When a correct code is registered by the door handle assembly 100, the keypad may initiate the lever 110 being extended or retracted. In embodiments where the lever 110 may be retracted independently of the locking status of the door handle assembly 100, the keypad 112 may also be used to facilitate locking or unlocking the door handle assembly 100 when different correct codes are entered by an operator. A fixed escutcheon 104 is disposed adjacent to the baseplate 102. The fixed escutcheon has a restricting surface 114 which prevents actuation of the lever 110 when the lever 110 is in the retracted configuration.

In FIG. 1, the door handle assembly 100 is in the extended configuration. Therefore, the fixed escutcheon 104 is not preventing the lever 110 from actuating. In the extended configuration, the lever 110 can move because the lever base 106 to which the lever is coupled is capable of rotating. Accordingly, there is no surface or structure that would obstruct or otherwise limit the movement of the lever 110. Additionally, in the extended configuration the lever 110 is distanced from the baseplate 102 which allows an operator to securely grasp the lever 110.

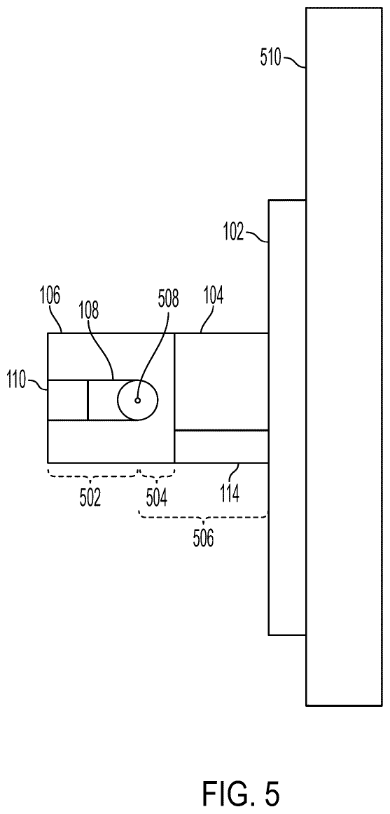

FIG. 1 also depicts a lever extender 108. The distal end of the lever extender 108 is connected to the lever 110. The proximal end of the lever extender may be attached to a motor which is capable of rotating the lever extender 108 with the lever 110 when activated. The motor may be at least partially housed within the lever base 106. The extender translates the rotational movement of the motor to positional movement. The lever extender accomplishes this positional movement by offsetting the axis of rotation from the lever. As would be understood by one of ordinary skill in the art, the length of the lever extender dictates the travel distance of the lever. The relevance of this distance is further elaborated on in the description of FIG. 5.

While the illustrated embodiment depicts a keypad 112 which is operated by a user in order to transition the lever 110 between an extended and retracted configuration, other embodiments are contemplated. For instance, any biometric or mechanical interface would be sufficient. This includes but is not limited to fingerprint scanning, iris scanning, retina scanning. face scanning, voice recognition, RFID key card identification, proximity card identification, magnetic stripe identification, barcode identification, lever keys, and pin cylindrical keys.

While the illustrated embodiment depicts the user interface 112 disposed on the baseplate 102, other embodiments are contemplated. For instance, the user interface 112 may be disposed on the outer surface of the lever base. In embodiments where the user interface 112 is an electronic authentication system where a key card is scanned, the user interface 112 may be in any portion of the door handle assembly which has space to house electrical components which can detect a key card and are known by those skilled in the art. In these embodiments, the baseplate may be smaller or may not exist.

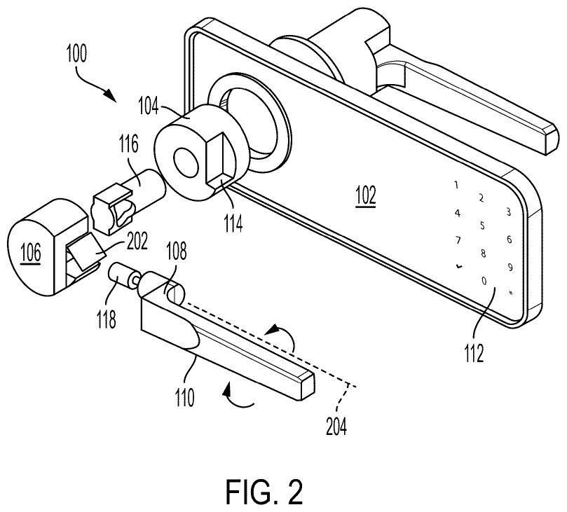

FIG. 2 illustrates an exploded view of the door handle assembly. The fixed escutcheon 104 and the restricting surface 114 can more easily and clearly be seen in this view. Additionally, a hole in the center of the escutcheon is present. The rotary shaft 116 extends through the hole. This feature allows for the fixed escutcheon 104 to be fixed while the lever 110, and the lever base 106 may rotate. An output shaft 118 is shown and connects to the lever extender 108. When the output shaft rotates, the lever extender 108 is transitioned between the retracted and extended configurations by rotating about an axis 204. The output shaft is shown positioned in a slot in the lever base which may be disposed on a motor 202. This positioning allows for lever to have a rolling functionality (transition between retracted to extended) along with the functionality to rotate the rotary shaft 116 and actuate the door handle assembly. It should be understood that the illustrated components and configurations depict one embodiment of the proposed door handle assembly. The rotary and output shafts may be in any position which allows for the lever to retract and extend as outlined in the current application.

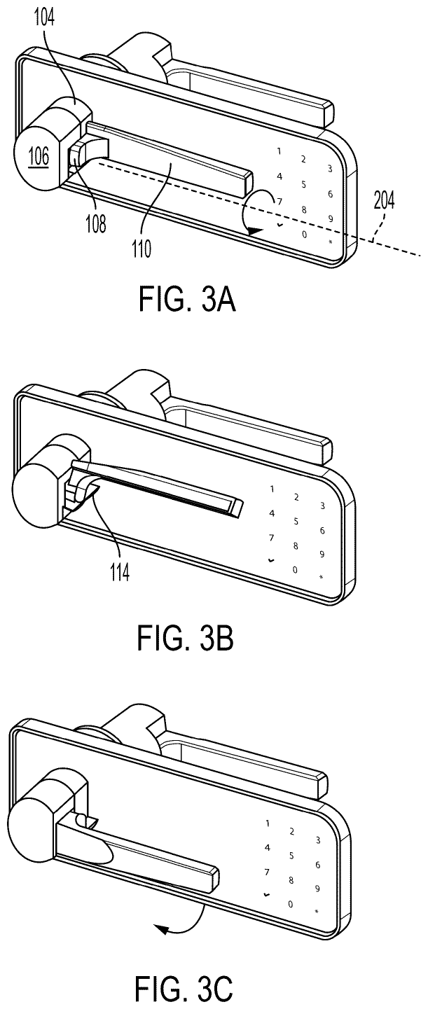

FIGS. 3A-3C illustrate the lever transitioning from the retracted state to the extended state. In the retracted configuration, the lever extender 108 and the lever 110 are unable to rotate due to the restricting surface which is a portion of the fixed escutcheon 104. The lever 110 may be transitioned to an extended configuration when the lever is rotated counterclockwise about the axis 204 where the lever extender 108 connects to the lever base 106. In the extended configuration the lever 110 and the lever extender 108 are no longer restricted by the restricting surface 114. Accordingly, an operator may grasp the lever and rotate the lever which rotates the rotary shaft.

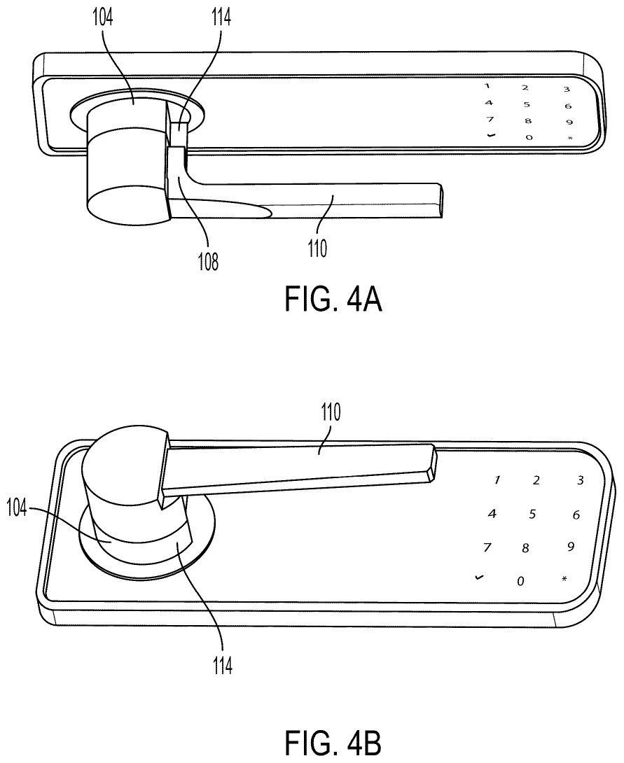

FIG. 4A depicts a top perspective view of the door handle assembly and FIG. 4B depicts a bottom perspective view of the door handle assembly. These figures illustrate an embodiment of the door handle assembly. As can clearly be seen, the restricting surface 114 extends from the fixed escutcheon 104. Additionally, the lever extender 108 and the restricting surface 114 exist on the same spatial plane. Accordingly, when the lever is rolled to the retracted configuration, the lever extender 108 will be positioned adjacent and parallel to the restricting surface 114. The lever extender 108 will contact the restricting surface 114 which is fixed and prevents the lever from pitching in the downward direction (as shown in the drawings) which would otherwise actuate the door handle assembly 100.

FIG. 5 illustrates the positioning requirements of the lever extender from a right-side perspective view including the door 510 which houses the door handle assembly. As seen in the figures disclosed above, the fixed escutcheon 104 and lever base 106 may extend from the baseplate 102. The lever extender 108 and lever 110 are illustrated protruding from the lever base 106. The lever 110 is fixed to the distal end of the lever extender 108 which rotates about a center point 508. The center point 508 is the region where the lever extender is connected to the lever base and may be described as the lever anchor point.

The lever extender length 502 should be longer than the distance between the center point 508 and the start of the restricting surface 114. This distance is the minimum lever extender length 504. If the lever extender 108 is shorter than the minimum lever extender length 504 then the lever 110 will not make contact with the restricting surface 114. Therefore, the lever extender 108 should be larger than the minimum lever extender length 504 in order to operate as intended. If the lever extender 108 does not make contact with the restricting surface 114 then downward force on the lever 110 would actuate the lever 110 and the retracted configuration would not restrict the movement of the lever 110.

The lever extender length 502 should be shorter than the distance between the center point 508 and the baseplate 102. This distance is the maximum lever extender length 506. If the lever extender 108 is longer than the maximum lever extender length 506 then the lever 110 will contact the baseplate and will not be able to rotate into the retracted configuration. Therefore, the lever extender 108 should be smaller than the maximum lever extender length 506 in order to operate as intended and allow the lever extender 108 to contact the restricting surface 114.

In an embodiment, the lever extender length 502 is approximately equal to the maximum lever extender length 506. In one embodiment, the lever extender length 502 should be as large as possible without contacting the baseplate. In this embodiment, the lever 110 would be substantially flush with the baseplate 102 when in the retracted configuration. In another embodiment, the outer surface of the lever 110 includes curved edges which allows for the lever extender length 502 to approach the exact length of the maximum lever extender length 506. In this regard, the curved edges provide clearance as the lever is rolled to the retracted configuration such that the edges of the lever 110 do not prematurely contacting the baseplate 102. In this embodiment, the lever 110 is disposed generally flush (and possibly even make contact) with the baseplate 102 when in the fully retracted configuration while also making contact with the restricting surface 114.

In some embodiments, the length of the fixed escutcheon 104 may be increased in order to create a bigger gap between the lever 110 and the baseplate 102. For example, embodiments with extended fixed escutcheons 104 may be beneficial in environments where operators are wearing gloves or have difficulties with dexterity. In these embodiments, the lever extender 108 may increase in order to maintain a flush fitting with the baseplate 102 when the lever 110 is in the retracted configuration. In other embodiments, the length of the lever base 106 may increase in order to obtain the same result. If the length of the lever base 106 increases, the lever extender 108 should increase in order to avoid falling below the minimum lever extender length 504 requirement.

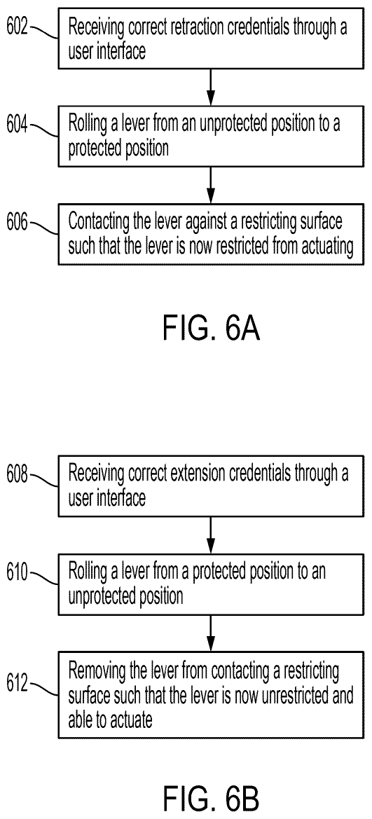

FIG. 6A illustrates one embodiment of a process in which the lever is retracted. As mentioned above, an operator may interact with a user interface in order to initiate the retraction. Accordingly, in some embodiments, at 602, the door handle assembly receives the correct credentials for retracting the lever. These credentials may be considered retraction credentials. At 604, the door handle assembly rolls the lever from an unprotected configuration to a protected configuration. Rolling the lever may comprise rolling the lever on an axis parallel to the lever but offset from a center of the lever such that the positioning of the lever changes, as previously discussed. In some embodiments, rolling the lever from an unprotected configuration to a protected configuration may comprise rotating counterclockwise. At 606, the lever may then contact a restricting surface such that the lever is now restricted from actuating.

FIG. 6B illustrates one embodiment of a process in which the lever is extended. As mentioned above, an operator may interact with a user interface in order to initiate the extension. Accordingly, in some embodiments, at 608, the door handle assembly receives the correct credentials for extending the lever. These credentials may be considered extension credentials. At 610, the door handle assembly may then roll the lever from a protected configuration to an unprotected configuration. Rolling the lever may comprise rolling the lever on an axis parallel to the lever but offset from a center of the lever such that the positioning of the lever changes. In some embodiments, rolling the lever from an unprotected configuration to a protected configuration may comprise rotating clockwise. At 612, the lever is now no longer contacting the restricting surface and may be able to actuate.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A self-protecting door handle assembly comprising:
a baseplate;
an escutcheon fixedly attached to the baseplate; and
a lever base protruding from the escutcheon wherein the lever base is rotatable; and
a lever extending adjacently from the lever base, wherein the lever is configured to roll into an extended configuration where the lever may pitch to allow operation of the door handle assembly and into a retracted configuration where the lever is inhibited from operating the door handle assembly.

2. The self-protecting door handle assembly of claim 1, further comprising a lever extender connecting the lever base to the lever.

3. The self-protecting door handle assembly of claim 1, further comprising a keypad disposed on the baseplate, wherein the keypad may initiate transitioning the door handle assembly from the extended configuration to the retracted configuration, and from the retracted configuration to the extended configuration.

4. The self-protecting door handle assembly of claim 1, further comprising a restricting surface disposed on the escutcheon where in the restricting surface contacts the lever when the door handle assembly is in the retracted configuration.

5. The self-protecting door handle assembly of claim 1, wherein the retracted configuration is a configuration where the lever is substantially flush with the baseplate, and actuation of the lever is restricted by a restricting surface.

6. The self-protecting door handle assembly of claim 2, wherein a length of the lever extender is approximately less than or equal to a distance from a lever anchor point to a base plate.

7. The self-protecting door handle assembly of claim 5, wherein a length of a lever extender is approximately greater than or equal to a distance from a lever anchor point to the restricting surface.

8. The self-protecting door handle assembly of claim 1, further comprising a motor proximally connected to the lever wherein the motor rotates the lever from the retracted configuration to the extended configuration and from the extended configuration to the retracted configuration.

9. The self-protecting door handle assembly of claim 8, wherein at least a portion of the motor is housed in the lever base.

10. A method of operating a self-protecting door handle assembly comprising:
receiving credentials through a user interface;
rolling a lever from an extended configuration to a retracted configuration, wherein rolling the lever comprises rolling the lever on an axis parallel to the lever but offset from a center of the lever such that the lever changes positions; and
contacting the lever against a restricting surface such that the lever is now restricted from actuating.

11. The method of claim 10, wherein rolling the lever comprises rolling the lever on the axis parallel to the lever but offset a distance less than the distance between a baseplate and a lever anchor point.

12. The method of claim 10, wherein rolling the lever comprises rolling the lever on the axis parallel to the lever but offset a distance greater than the distance between the restricting surface and a lever anchor point.

13. The method of claim 10, wherein receiving the credentials through the user interface comprises registering a correct code inputted on a keypad.

14. The method of claim 10, wherein rolling the lever from the extended configuration to the retracted configuration comprises activating a motor which rotates an output shaft clockwise.

15. A method of operating a self-protecting door handle assembly comprising:
receiving credentials through a user interface;
rolling a lever from a retracted configuration to an extended configuration, wherein rolling the lever consists of rolling the lever on an axis parallel to the lever but offset from a center of the lever such that the lever changes positions; and
removing the lever from contacting a restricting surface such that the lever is now unrestricted and able to actuate.

16. The method of claim 15, wherein rolling the lever comprises rolling the lever on the axis parallel to the lever but offset a distance less than the distance between a baseplate and a lever anchor point.

17. The method of claim 15, wherein rolling the lever comprises rolling the lever on the axis parallel to the lever but offset a distance greater than the distance between the restricting surface and a lever anchor point.

18. The method of claim 15, wherein receiving the credentials through the user interface comprises registering a correct code inputted on a keypad.

19. The method of claim 15, wherein rolling the lever from the retracted configuration to the extended configuration comprises activating a motor which rotates an output shaft counterclockwise.
